(19) United States
(12) Patent Application Publication
(10) Pub. No.: US 2007/0096372 A1
(43) Pub. Date: May 3, 2007

(54) Method of manufacturing melt blown carbon fiber filter element and apparatus used therein

(76) Inventors: Wang Qinhua, Foshan (CN); Dean Cheng, San Jose, CA (US)

Correspondence Address: GLOBAL IP SERVICES, 2462 ROCK ST., APT. 6, MOUNTAIN VIEW, CA, 94043, US

(21) Appl. No.: 11/263,644

(22) Filed: Oct. 31, 2005

(51) Int. Cl. B28B 3/00

(52) U.S. Cl. 264/640

(57) ABSTRACT

The invention discloses a method of manufacturing melt blown style activated carbon fiber filter elements, which comprises: putting polypropylene resin into plastic pressing machine, then melting it at high temperature, after pressing, the liquid polypropylene is produced and transported to fiber-injector, and spraying the melted liquid polypropylene to fiber-receiving device in fiber form, transporting activated carbon to fixed position of fiber-receiving device, by fiber-receiving device's inertia, polypropylene fiber can join activated carbon to produce filter cartridge in pre-set inner and outer diameters. This invention can reduce cost effectively and many different micron rating filtration elements can be easily produced automatically. Both of New activated carbon fiber filter cartridges and filter cloth are of excellent performance and long-service life.

### FIELD OF THE INVENTION

The invention is related to activated carbon fiber filter elements, method for manufacturing melt blown style of activated carbon fiber filter cartridges, and method for manufacturing activated carbon fiber filter cloth.

### BACKGROUND OF THE INVENTION

As the major component of filtration system, the quality of the activated carbon fiber filter cartridge directly affects not only reliability of the filtration system, operating cost, but also working performance, safety and service life of the filtration system.

In the filter industry today, most of the existing activated carbon filter cloths are made of gumming method. Examples of such formed activated carbon filter cloths are air-conditioned filters, liquid filter cartridges, and gas masks etc. The conventional gumming manufacturing processes of making activated carbon filter cloth are as follows: selecting proper filter cloth and letting it soaked up the special liquid glue first, then covering another filter cloth after evenly agglutinating granular activated carbon or powders to the surface of the filter cloth. Finally, the activated carbon filter cloth is formed and the whole process is finished. But the following disadvantages exist in this manufacturing process illustrated above. Firstly, the manufacturing cost is high. Secondly, due to necessity of the adhesive for attaching the activated carbon to the surface of the filter cloth, the distribution of the carbon powders or particles is not uniform. Thirdly, the activated carbon is susceptible to be peeled off from the surface of the filter cloth due to some factors. Finally, the filter cloth suffers from high pressure drop, low flux, short service life and poor performance.

Thus, there is a need for an improved method of manufacturing melt blown carbon fiber filter element and apparatus implemented thereof that does not suffer from the above-mentioned drawbacks.

### SUMMARY OF THE INVENTION

To overcome these disadvantages shown in prior art technology and improve the performance of the filter cloth, the invention provides a new method of making the melt blown style activated carbon fiber filter cartridges and cloths.

The invention also provides a set of processing devices used in the method for making the melt blown style activated carbon fiber filter cartridges and cloths.

The adopted technical scheme of melt blown style activated carbon fiber filter manufacturing process comprises steps of: delivering polypropylene resin into a plastic pressing machine and melting the polypropylene resin by high temperature into liquid state, then conducting the melted liquid polypropylene to a fiber-injector, spraying the melted liquid polypropylene into divided fibers such that a fiber receiving device is shot by said fibers, using a carbon feeder to transport activated carbon material to the same fiber receiving device, by the movement of the fiber receiving device, the melted polypropylene fiber joins activated carbon evenly and tightly in a interlacing form. Using the manufacturing method described above, a variety of filter elements may be fabricated according to inner and outer diameter size of the filter element to be desired.

The invention also provides a set of processing devices used for manufacturing said melt blown style activated carbon filters. The devices include a plastic pressing machine, a fiber-injector, a carbon feeder and a fiber-receiving device. Said plastic pressing machine is utilized to inhale polypropylene plastic resins and melt the polypropylene plastic resins into liquid state, then transfer the melted polypropylene plastic resins to said fiber-injector, said fiber-injector being used for spraying said melted polypropylene plastic resins in form of fibers to said fiber receiving device. The activated carbon feeder device is applied to transport activated carbon powders to the fiber-receiving device. The fiber-receiving device joins the melted polypropylene fibers with the activated carbon powders evenly to produce filter elements.

The advantages of the invention are producing activated carbon fiber filter elements by melt blown is simple and economical, which can reduce material consumption and labor cost; process of soaking materials in liquid-gum which exists in conventional method is avoided in the method of the invention; the polypropylene plastic resins and the carbon are self-bonded to each other with no chemical binder, and the polypropylene fiber joins with the activated carbon evenly and tightly; the method of the invention has the capability of producing various activated carbon fiber filter elements with different porous size; in addition, the filter element formed by the method of the invention has good filtration performance, long operating life and low pressure drop.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this invention. In such drawings:

FIG. 1 is an illustration of process of manufacturing melt blown style activated carbon fiber filter elements;

FIG. 2 is a perspective view of devices used in manufacturing process shown in FIG. 1;

FIG. 3 is a flowchart of the processing shown in FIGS. 1 and 2; and

FIG. 4 is a view of a bridge forming manner in which the activated carbon fiber filter elements are formed gradually.

### DETAILED DESCRIPTION OF ILLUSTRATED EMBODIMENTS

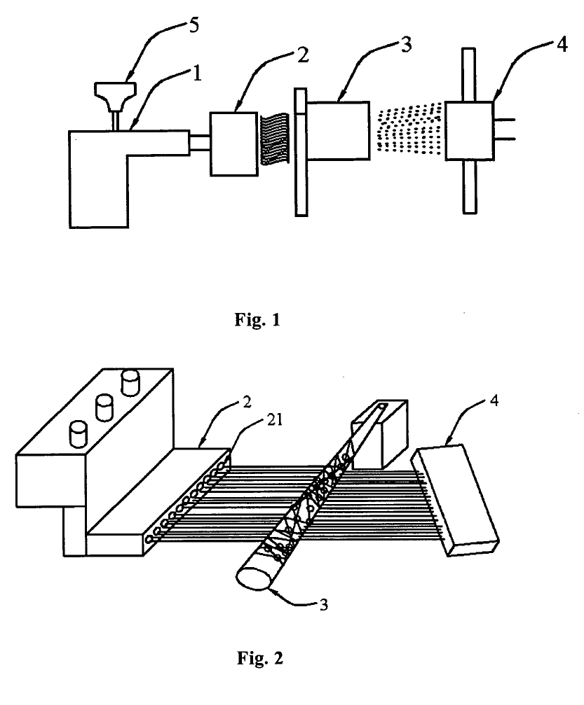

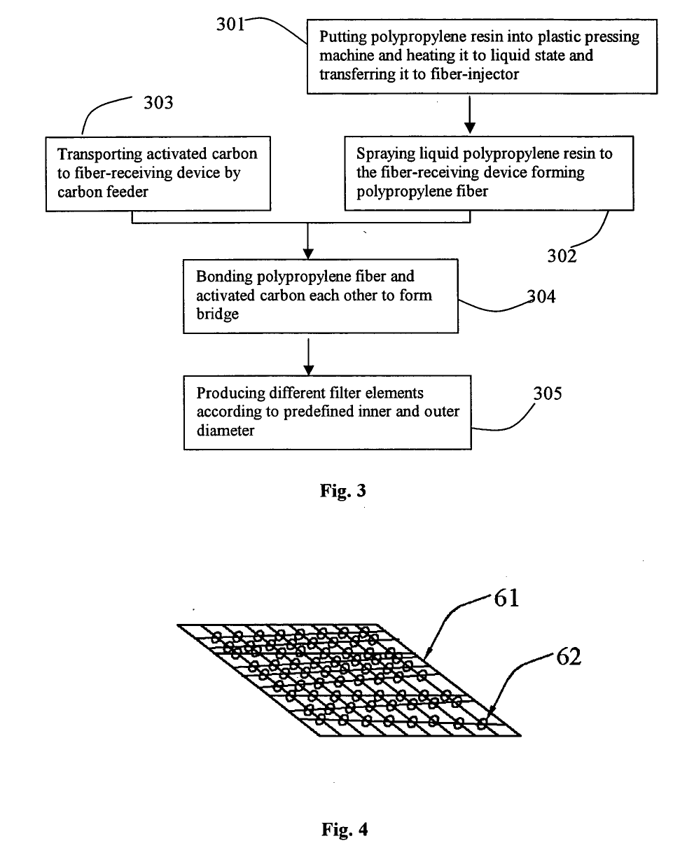

As shown in FIGS. 1 to 4, activated carbon fiber filter elements such as filter cartridges and filter cloth are manufactured by the method of the invention using materials such as polypropylene and activated carbon. A set of devices used in the method includes: a plastic pressing machine 1, a fiber-injector 2, a carbon feeder 4 and a fiber-receiving device 3. The plastic pressing machine 1 is applied to inhale polypropylene resin 5 and melt it into liquid state then transfer to the fiber-receiving device 3 in a fiber form. The carbon feeder 4 is applied to transport activated carbon 62 to the fiber-receiving device 3. The fiber-injector 2 has a plurality of output ports 21 used for spraying and dividing the melt polypropylene resin 5 into fibers 61 and making them be transferred to the fiber-receiving device 3, said fiber-receiving device 3 being capable of joining polypropylene fibers 61 and activated carbon 62 evenly, thus making them wrapped together on the fiber-receiving device 3 to form a filter element. The fiber-receiving device 3 may take different configuration for producing different type of activated carbon fiber filter elements such as spinning configuration for filter cartridge and plane configuration for filter cloth.

The method of the invention is performed by the following steps: Step 301 includes inhaling polypropylene resin 5 into plastic pressing machine 1, then melting polypropylene resin 5 at 280° C., and pressing the polypropylene resin 5 with the operating pressure falling within 2.5 kg-10 kg/cm2 to make the polypropylene resin 5 melted and transferred to the fiber-injector 2; followed is Step 302, which involves spraying the liquid polypropylene resin 5 by the fiber-injector 2 from pluralities of output ports 21 of the fiber-injector 2 to the fiber-receiving device 3 in a fiber form. Then in step 303 which is performed simultaneously with the step 302, the carbon feeder 4 transports the activated carbon 62 to the fiber-receiving device 3, said device 3 can adsorb the polypropylene fiber 61 and activated carbon 62 thereto. Then in step 304, by receiving function of the fiber-receiving device 3, the polypropylene fiber 61 and the activated carbon 62 are bonded each other to form bridge evenly and tightly. The fiber-receiving device 3 may take different configuration for producing different type of activated carbon fiber filter elements such as spinning configuration for filter cartridge and plane configuration for filter cloth. The final step 305 relates to producing different filter elements according to predefined inner and outer diameter, e.g. column filter element or a plurality of produce polypropylene fiber filter cloth of a fixed size.

In the above steps, adjusting the thickness of the polypropylene fiber 61 and the distance of the fiber-receiving device 3 can produce different filtration elements. Because of the multi-layers of polypropylene, the filter apertures are very small, and the filterable particle ≦0.5 μm.

This invention adopts bridge-forming method in which the polypropylene fiber 61 and the activated carbon 62 are enwound together. By the carbon feeder 4, the activated carbon 62 is transferred to the fiber-receiving device 3 and joins the polypropylene fiber 61 under high temperature. The activated carbon 62 is bonded to the polypropylene fiber 61 time and again and both interlace together to form filter apertures even and tightly. When the outer diameter reaches the set size, compound fiber activated carbon filter cartridges are produced or an activated carbon polypropylene fiber filter cloth within a pre-set size is formed.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A method of manufacturing melt blown carbon fiber filter elements comprises steps of:
a. melting a polypropylene resin to form liquid polypropylene at high temperature;
b. forming polypropylene fibers from said liquid polypropylene;
c. blowing activated carbons to said polypropylene fibers before it changing into curd;
d. said polypropylene fibers join with said activated carbon;
e. making said melt blown carbon fiber filter elements from said polypropylene fiber joined with activated carbon.

2. The method as claimed in claim 1, wherein said high temperature is 280° C.

3. The method as claimed in claim 1, wherein said liquid polypropylene is pressed to move through a fiber-injector to spray as polypropylene fibers, the operating pressure is between 2.5 kg-10 kg/cm².

4. The method as claimed in claim 1, wherein said polypropylene fibers join with said activated carbon by bridge forming, said polypropylene fibers and said activated carbon enwind together equally and tightly.

5. The method as claimed in claim 4, wherein the process of said polypropylene fibers joining with said activated carbon is in a fiber-receiving device.

6. The method as claimed in claim 1, wherein the apertures of said melt blown carbon fiber filter elements is adjusted by the thickness of said polypropylene fiber.

7. The method as claimed in claim 5, wherein adjusting the thickness of said polypropylene fiber and the distance of said fiber-receiving device to produce different filtration elements.

8. An melt blown carbon fiber filter element made by the method of claim 1, comprising polypropylene fibers joined with activated carbon fibers

9. The melt blown carbon fiber filter element as claimed in claim 8, wherein said polypropylene fibers join with said activated carbon by bridge forming, said polypropylene resin and said activated carbon are enwound together equally and tightly.

10. The melt blown carbon fiber filter element as claimed in claim 8, wherein filterable particles are ≧0.5 μm

11. The melt blown carbon fiber filter element claimed in claim 8, wherein it including activated carbon fiber filter cartridge and activated carbon fiber filter cloth.

12. A system used for the method of claim 1 comprising:
a plastic pressing machine for inhaling then melting polypropylene resin into liquid state and transport said liquid polypropylene to a fiber-injector;
said fiber-injector for spraying said liquid polypropylene as polypropylene fiber into a fiber-receiving device;
an activated carbon feeder device for transporting activated carbons to said fiber-receiving device;
said fiber-receiving device for receiving said polypropylene fibers and said activated carbon and joining them together to become melt blown carbon fiber filter elements.

13. The system as claimed in claim 12, wherein said fiber-receiving device may take different configuration for producing different type of activated carbon fiber filter elements

14. The system as claimed in claim 12, wherein the distance of said fiber-receiving device can be adjusted for producing different filtration elements.

15. The system as claimed in claim 12, wherein said melt blown carbon fiber filter elements including filter cartridges and filter cloth.
